(19) United States
(12) Patent Application Publication
(10) Pub. No.: US 2026/0113630 A1
(43) Pub. Date: Apr. 23, 2026

(54) BSS MEMBERSHIP SELECTOR BASED SIGNALING TO AUTHENTICATE SEAMLESS MOBILITY DOMAIN

(71) Applicant: Cisco Technology, Inc., San Jose, CA (US)

(72) Inventors: Binita GUPTA, San Diego, CA (US); Stephen M. ORR, Wallkill, NY (US); Brian D. HART, Sunnyvale, CA (US)

(21) Appl. No.: 19/212,500

(22) Filed: May 19, 2025

Related U.S. Application Data
(60) Provisional application No. 63/709,103, filed on Oct. 18, 2024.

(51) Int. Cl. H04W 12/06; H04W 12/73; H04W 76/15

(52) U.S. Cl. CPC H04W 12/06; H04W 12/73; H04W 76/15

(57) ABSTRACT

Transmission of a signal from an access point on a mobility domain to a client device. The signal indicates that the client device should perform an authentication process before joining the mobility domain. By authenticating the mobility domain, the client device ensures that it is not joining a rogue access point mimicking an access point of the mobility domain.

### CROSS-REFERENCE TO RELATED APPLICATIONS

This application claims benefit of U.S. provisional patent application Ser. No. 63/709,103 filed Oct. 18, 2024. The aforementioned related patent application is herein incorporated by reference in its entirety.

### TECHNICAL FIELD

Embodiments presented in this disclosure generally relate to seamless mobility domains. More specifically, embodiments disclosed herein transmitting a signal for a station to authenticate a seamless mobility domain.

### BACKGROUND

Support for seamless roaming capability is being considered for IEEE 802.11bn (e.g., Wi-Fi 8) to improve Wi-Fi roaming quality. To support seamless roaming in a Wi-Fi network, client devices can associate with a seamless mobility domain (SMD) that includes multiple Access Point (AP) Multi-Link Devices (MLDs) (e.g. an SMD covering AP MLDs in a campus-network) instead of associating with an individual AP MLD. An extended service set (ESS) might be represented by one or more seamless mobility domains or there can be multiple hierarchy of mobility domains, e.g. one or more Fast Transition (FT) mobility domains, each including one or more SMDs. A client can roam seamlessly across APs/AP MLDs of a SMD.

The client creates its association with the SMD in the ESS network, instead of associating with a single AP MLD within the ESS. Clients may cryptographically establish trust and authenticate an SMD (or SMD MLD) using a digital signature. However, there can be rogue APs which can replay the digital signature at a later point in time on the same channel masquerading as a genuine AP (MLD) and act as MITM (Man-In-The Middle) attacker.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts a block diagram of several access points (APs) and a rogue AP transmitting a message to a client device, according to one embodiment.

FIG. 2 depicts a flowchart for indicating to a client device that it should authenticate the mobility domain, according to one embodiment.

FIGS. 3A-3D depicts information that is included in a message to a client device, according to several embodiments.

FIG. 4 depicts a flowchart of a client device processing signals from multiple APs, according to one embodiment.

FIG. 5 illustrates an example workflow for generating a seamless mobility domain (SMD) signature, according to certain embodiments.

FIG. 6 an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes transmitting, from an access point, a signal to a client device indicating the client device should perform an authentication process to authenticate a mobility domain before joining the mobility domain, which includes the access point being part of the mobility domain. The method further includes performing the authentication process with the client device to authenticate the mobility domain.

### Example Embodiments

A seamless mobility domain (SMD) may have devices authenticate the SMD through an access point (AP) advertising that it is part of the SMD before connecting to the SMD. In some embodiments, the AP transmits a value in a beacon and/or a probe response frame to indicate that a device should authenticate the SMD before associating with the SMD. In some embodiments, the transmitted value is in a Basic Service Set (BSS) membership selector, a Robust Security Network Element (RSNE), or in Robust Security Network Extension Element (RSNXE).

A rogue AP may advertise that it is associated with the SMD to trick devices into connecting into joining the rogue AP. When a device joins a rogue AP, data from the device may be accessed by a nefarious actor. But by having the device authenticate the SMD before joining, the devices can determine whether the AP they are communicating with is a rogue AP.

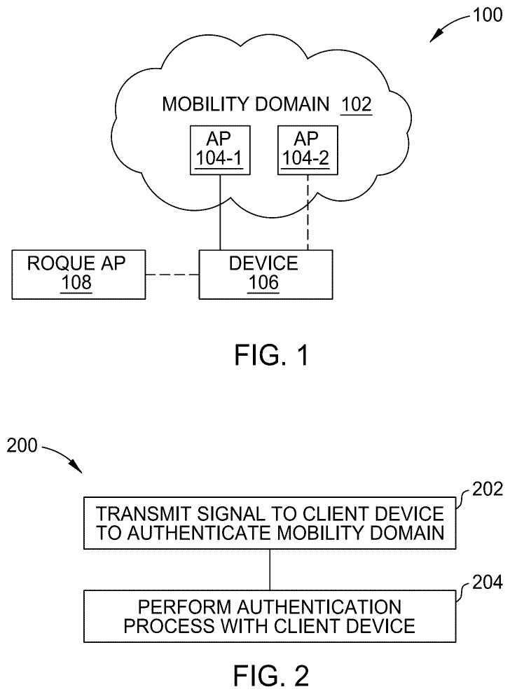

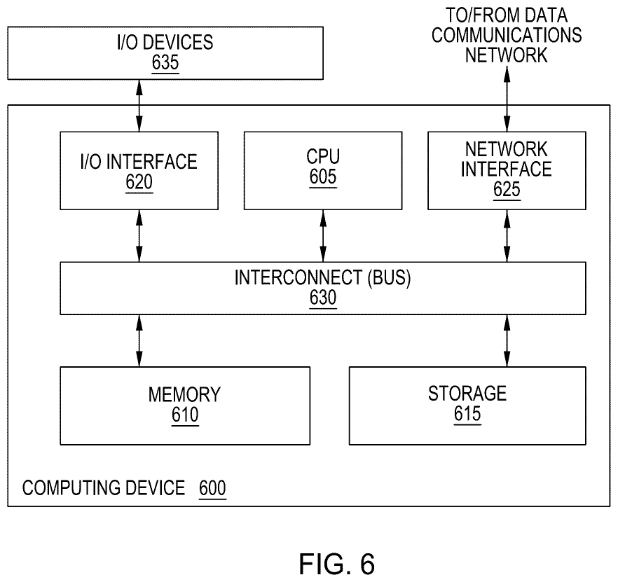

FIG. 1 depicts an environment 100 with a rogue access point and a mobility domain with APs that are advertising that they are part of the mobility domain. In one embodiment, the mobility domain may be a SMD, which includes multiple frequency bands or channels for multiple devices to send data through the mobility domain concurrently. By having an SMD, a device that connects to the SMD can stay connected to the mobility domain without re-authentication when switching between different APs on the SMD. In an illustrated embodiment, a mobility domain 102 includes APs 104-1 and 104-2. In some embodiments, a device 106 may attempt to connect to the mobility domain 102. The device 106 may be a client device, such as a station (STA) (e.g., a laptop, a desktop computer, a smartphone, a tablet, a non-AP MLD, and the like). In one embodiment, the AP's 104-1 or 104-2 may transmit a beacon signal indicating that they are part of the mobility domain 102 and that the device 106 can connect to the mobility domain 102 through one the APs 104-1 or 104-2. In one embodiment, the beacon signal indicates that the device 106 should authenticate the mobility domain 102 before connecting. The authentication process is further explained in FIG. 6.

The environment 100 may include a rogue AP 108 that may transmit a beacon that advertises itself as part of the mobility domain 102. When a device, such as the device 106, joins the rogue AP 108, the data sent from the device 106 would be available to a nefarious actor. In one embodiment, the device 106 may receive a signal from multiple APs advertising that they are part of the mobility domain 102. In an illustrated embodiment, the AP 104-1, the AP 104-2, and the rogue AP 108 each send a signal to the device 106, indicated by lines going to the device 106, advertising the same mobility domain 102. The signals from the AP 104-1 and 104-2 may indicate that the device 106 should authenticate the mobility domain 102 before joining, but the signal from the rogue AP 108 may not indicate that the device 106 should authenticate. That is, a nefarious actor would not want the rogue AP 108 to indicate that authentication should be performed since this means the device 106 would detect that the rogue AP 108 is not part of the mobility domain 102. However, when the device 106 receives at least one signal indicating that it should authenticate, in one embodiment, the device 106 may begin the authentication process for the mobility domain 102. As such, so long as the device 106 receives a signal from at least one non-rogue AP, the device 106 will authenticate when joining the mobility domain 102, and thus detect a rogue AP. In an illustrated embodiment, the device 106 joins the mobility domain 102 through the AP 104-1, indicated by the solid line in FIG. 1.

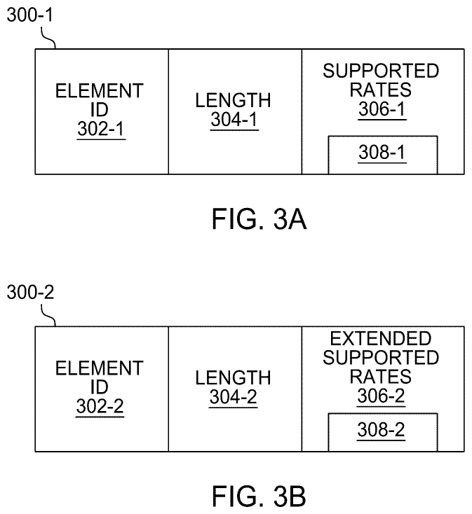

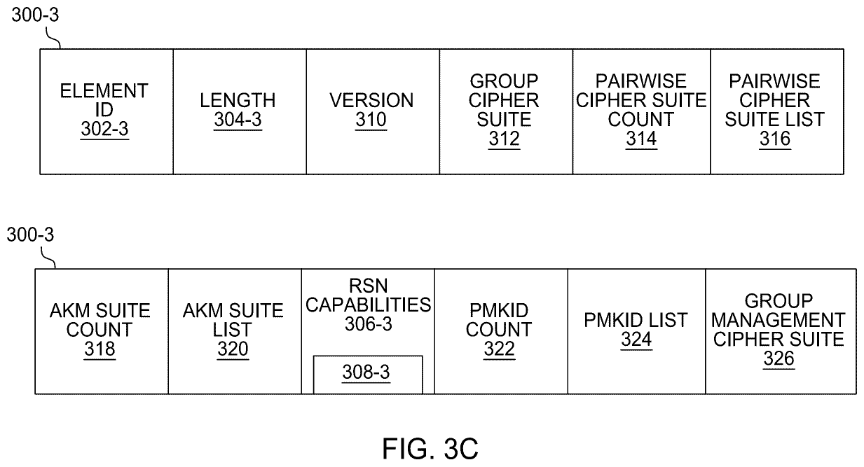

FIG. 2 depicts a flowchart for indicating to a client device that it should authenticate the mobility domain. At block 202, an AP (e.g., the AP 104-1 or 104-2 in FIG. 1) transmits a message to a client device (e.g., the device 106 in FIG. 1) indicating the client device should authenticate a mobility domain (e.g., the mobility domain 102 in FIG. 1). In one embodiment, the message is a probe response signal in response to a probe request from the client device. In one embodiment, the message is a beacon signal from the AP advertising that it is part of the mobility domain. Regardless of the type of signal, the signal may include a value indicating the client device should authenticate the mobility domain. In some embodiments, the value may be in a BSS membership selector, a RSNE, or in a RSNXE. Each of these are further described in FIGS. 3A-3D.

At block 204, the AP performs an authentication process with the client device. To help prevent the client device is not connecting to a rogue AP (e.g., the rogue AP 108 in FIG. 1), the client device performs the authentication process with the AP that it is using to connect to the mobility domain. An embodiment of the authentication process is further explained in FIG. 6.

FIG. 3A-3D depicts formats 300-1 through 300-4, respectively, for information that is included in a message to a client device (e.g., the device 106 in FIG. 1). Whether the signal is a beacon, probe response, or another type of signal, the signal may include values indicating that the client device should authenticate a mobility domain (e.g., the mobility domain 102 in FIG. 1) through an AP (e.g., the AP 104-1 or 104-2). In one embodiment, the signal may include a BSS membership selector element with supported rates. According to IEEE 802.11, the format 300-1 for the BSS membership selector element with supported rates includes fields for element ID 302-1, length 304-1, and supported rates 306-1. The element ID 302-1 and the length 304-1 may include one octet of data each while the supported rates 306-1 may include one to eight octets of data. In one embodiment, value 308-1 may be inside of the supported rates 306-1, which indicates that the client device should authenticate the mobility domain. Other information for the signal may be in each of the octets of the signal beyond the value indicating the client should authenticate the mobility domain.

In one embodiment, the signal may include a BSS membership selector element with extended supported rates, as shown in FIG. 3B. According to IEEE 802.11, the format 300-2 for the BSS membership selector element with extended supported rates includes fields for element ID 302-2, length 304-2, and extended supported rates 306-2. The element ID 302-2 and the length 304-2 may include one octet of data each while the extended supported rates 306-2 may include one to 255 octets of data. In one embodiment, value 308-2 may be inside of the extended supported rates 306-2, which indicates that the client device should authenticate the mobility domain. Other information for the signal may be in each of the octets of the signal beyond the value indicating the client should authenticate the mobility domain.

In one embodiment, the signal may include a RSNE, as shown in FIG. 3C. According to IEEE 802.11, the format 300-3 for the RSNE includes fields for element ID 302-3, length 304-3, Robust Security Network (RSN) capabilities 306-3, version 310, group cipher suite 312, pairwise cipher suite count 314, pairwise cipher suite list 316, Authentication Key Management (AKM) suite count 318, AKM suite list 320, Pairwise Master Key ID (PMKID) count 322, PMKID list 324, and group management cipher suite 326. The element ID 302-3 and the length 304-3 may include one octet of data each. The version 310, the pairwise cipher suite count 314, the AKM suite count 318, the RSN capabilities 306-3, and the PMKID count 322 may include two octets of data each. The pairwise cipher suite list 316 is based on four times the pairwise cipher suite count 314, the AKM suite list 320 is based on four times the AKM suite count 318, and the PMKID list 324 is based on sixteen times the PMKID count 322. In one embodiment, value 308-3 may be inside of the RSN capabilities 306-2, which indicates that the client device should authenticate the mobility domain. Other information for the signal may be in each of the octets of the signal beyond the value indicating the client should authenticate the mobility domain.

In one embodiment, the signal may include a RSNXE, as shown in FIG. 3D. According to IEEE 802.11, the format 300-4 for the RSNXE includes fields for element ID 302-4, length 304-4, and extended RSN capabilities 306-4. The element ID 302-4 and the length 304-4 may include one octet of data each while the extended RSN capabilities 306-4 may be a number of octets based on a number indicated in the first four bits of the extended RSN capabilities field 306-4. In one embodiment, value 308-4 may be inside of the extended RSN capabilities field 306-4, which indicates that the client device should authenticate the mobility domain. Other information for the signal may be in each of the octets of the signal beyond the value indicating the client should authenticate the mobility domain.

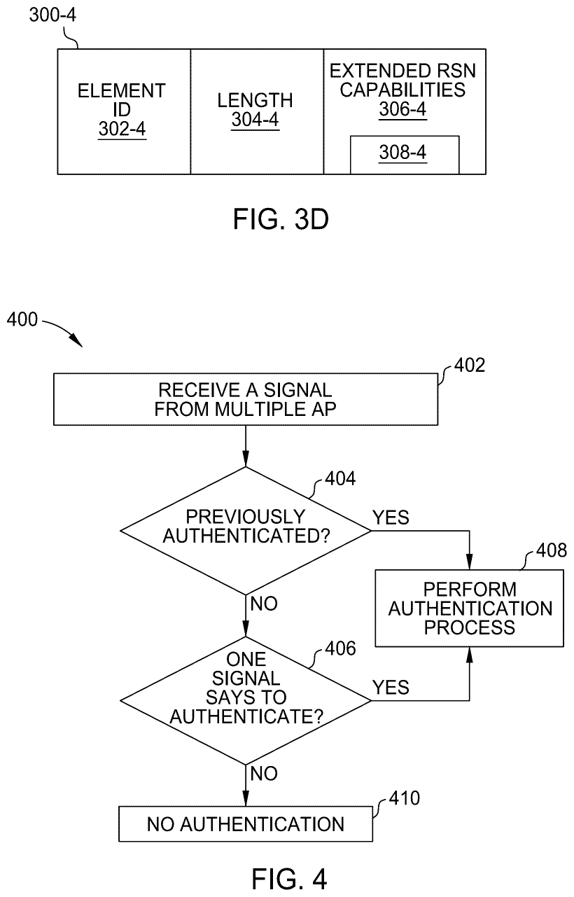

FIG. 4 depicts a flowchart of a method 400 for a client device (e.g., the device 106 in FIG. 1) processing signals from a plurality of APs. At block 402, the client device may receive a signal from a first AP (e.g., the AP 104-1 in FIG. 1) and a second AP (e.g., the rogue AP 108 in FIG. 1). The signal may be a beacon from both APs or a probe response from both APs in response to a probe request from the client device or an unsolicited probe response. In one embodiment, the first AP transmits a signal to the client device indicating the client device should authenticate and the second AP transmits a signal to the client device, but does not indicate the client device should authenticate.

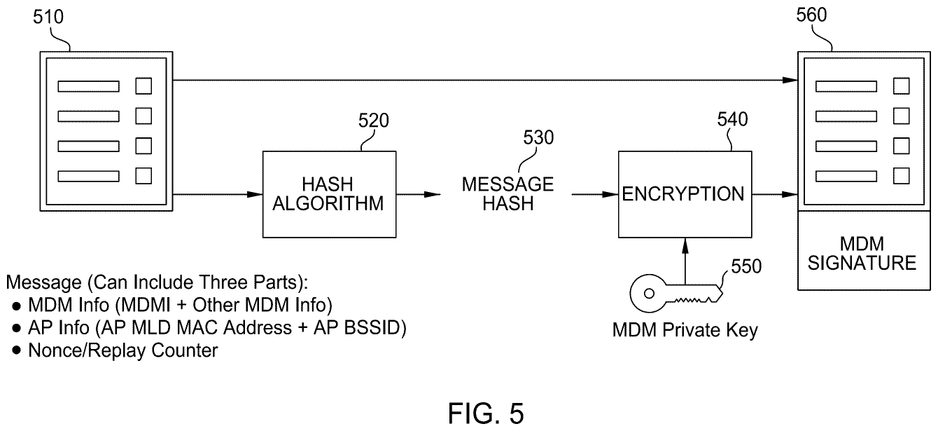

At block 404, the client device determines if it has previously authenticated the mobility domain. The client device may, in one embodiment, authenticate the mobility domain and save an identifier related to the mobility domain indicating that the client device authenticated the mobility domain. In one embodiment, the client device determines that it has previously authenticated the mobility domain and the method 400 proceeds to block 408. The authentication of mobility domain (or SMD) involves verifying the SMD Signature received from the AP as described in the context of FIG. 5 below. In an embodiment where the client device did not authenticate the mobility domain, the method 400 proceeds to block 406.

At block 406, the client device determines if one of the signals from the plurality of APs indicates that the client device should authenticate. A rogue AP (e.g., the rogue AP 108 in FIG. 1) would likely not indicate that the client device should authenticate with the mobility domain since the rogue AP would likely not have the information necessary to authenticate the client device with the mobility domain. A legitimate AP that is associated with the mobility domain can, for example, perform a nonce exchange with the client device for the client device to authenticate the mobility domain. In one embodiment, the client device receives a signal from the first AP indicating that the client device should authenticate the mobility domain and the method 400 proceeds to block 408. In one embodiment, the client device does not receive a signal from either AP indicating that it should authenticate the mobility domain and the method 400 proceeds to block 410.

At block 410, the client device does not authenticate the mobility domain. In one embodiment, this may be due to the mobility domain not using an authentication process or the client device may not support the authentication process.

### The following description describes one or more embodiments of this disclosure.

As noted herein, to provide smooth roaming/mobility in a campus wide wireless network, clients can create a “secure association” with an ESS instead of with an individual AP MLD. The ESS, for example, may be a global network with one or more campuses or a campus-wide network. In embodiments where the ESS is a global network with one or more campuses, each campus may correspond to (or be associated with) a respective SMD. On the other hand, in embodiments where the ESS maps to a single campus, the ESS may include a single SMD associated with campus.

In many wireless networks, “association” by a client generally refers to both the AP (MLD) through which the client transfers data (e.g., data plane) and the unicast keys used with that AP (MLD) for data transfer. As used herein, the term “secure association” generally refers to the later aspect of “association,” namely the transfer of the unicast keys used with an AP (MLD) for data transfer.

In certain embodiments described herein, the client (e.g., an STA MLD) creates its secure association with the ESS network represented by an SMD (e.g., the mobility domain 102 in FIG. 1), instead of associating with a single AP (MLD) within the ESS network. As noted, associating with the SMD instead of a single AP MLD may enable the client to roam seamlessly among the AP MLDs within the SMD without requiring (re)association and re-establishment of contexts with each new AP MLD, significantly reducing roaming time and improving the client's wireless performance.

In certain embodiments, affiliated APs (e.g., the AP 104-1 or 104-2 in FIG. 1) of an AP MLD that is part of an SMD (e.g., the mobility domain 102 in FIG. 1) advertise the SMD identifier (e.g., SMD MAC address or Mobility Domain MLD Identifier (MDMI)) in the beacon and probe response frames, so that STA MLDs (e.g., the device 106 in FIG. 1) can identify which APs are part of the SMD (or Mobility Domain MLD (MDM)). However, in some cases, there may be rogue APs within the network that masquerade as legitimate APs of the SMD. Accordingly, one of the challenges with advertising the SMD identifier relates to how a client can establish trust for the SMD identifiers that are being advertised (and hence the transmitter's membership within an SMD) from nearby AP(s).

For instance, without establishing cryptographic trust for the advertised SMD identifier, a client (e.g., the device 106 in FIG. 1) may connect to a rogue AP (e.g. the rogue AP 108) acting as a man-in-the-middle (MITM) for a legitimate AP connected to the campus network. Since techniques described herein allow the client to establish association once with the SMD, as opposed to requiring the client to establish association separately with each AP MLD, from a security perspective, it is crucial that the client ensures that it is connecting to a legitimate AP (MLD) of the SMD at the time of data transfer with the SMD.

To address this, certain embodiments described herein provide techniques for cryptographic Identification of a SMD MLD for seamless roaming. As described herein, certain embodiments define a mechanism such that a client can cryptographically establish trust for (i) the SMD and (ii) verify whether an AP (MLD) is indeed part of an SMD before performing data transfer with the AP (MLD).

In certain embodiments, the client establishes trust with the SMD before performing a secure association with the SMD, and validates that an AP (MLD) claiming to be part of the SMD is indeed a part of the SMD.

In certain embodiments, the SMD identifier associated with the SMD may be used for cryptographic identification. Any one of the following may be used as a SMD identifier: (i) a SMD MAC address (distinct from an 802.11be MLD address or replacement thereof as indicated by an association), (ii) a globally unique 48-bit identifier, and (iii) a unique identifier assigned for each SMD, such as a Network Interface Device (NID).

Additionally, in certain embodiments, a SMD may be assigned an optional user-friendly identifier referred to as a SMD MLD name (e.g., username) for display purposes to end users. The SMD MLD name can be advertised using a similar scheme for the unique SMD identifier described herein. By way of example, in certain embodiments, an SMD MLD information element (IE) may be included in the beacon and probe response frames and may include SMD information, such as the SMD identifier and SMD MLD name, as illustrative examples, along with SMD authentication check information for establishing trust for an SMD. Note the SMD authentication check information is described in greater detail herein.

In certain embodiments, the client can employ a trust on first use (TOFU) authentication technique to establish trust for a SMD. In TOFU authentication, when a client discovers a SMD (e.g., from a SMD MLD IE received in a beacon frame which is not in the list of trusted SMDs), the client can present the SMD information, such as the SMD MLD name, SMD identifier, corresponding public key, among other information, to the end user in order to verify that the user trusts the SMD. If the end user verifies that the end user trusts the SMD, then the client can store an indication that the SMD is trusted.

Additionally, in TOFU authentication, the client may further verify that the affiliated AP (e.g., the AP 104-1 or 104-2 in FIG. 1) and the AP MLD is indeed part of that SMD. For this purpose, a public/private key pair can be generated for the SMD, e.g., by a controller or one of the AP MLDs. The public key corresponding to an SMD identifier (e.g., MDMI) can be shared with clients through various methods, such as via broadcast to clients in beacons, as an illustrative example. Each AP transmitting the SMD identifier in the beacon may obtain the SMD information as well as AP MLD information (e.g. AP MLD MAC address, AP basic service set identifier (BSSID), etc.) signed by the entity holding the SMD private key. To avoid replay attacks, a nonce/Replay counter can be included in the SMD signature generation.

FIG. 5 illustrates an example workflow 500 for generating an SMD signature (or MDM Signature), according to certain embodiments. Note the example workflow 500 may be used any of the techniques described herein for cryptographically establishing trust with an SMD, such as TOFU authentication, public key infrastructure (PKI) authentication, and certificate authority (CA) signed-certificate based authentication. Note, PKI authentication and CA signed-certificate based authentication are described in greater detail below.

As shown in FIG. 5, the SMD signature generation may involve an AP (MLD) generating a message 510 (e.g., beacon) that includes SMD information, AP information, a nonce/replay counter, operating channel information, or any combination thereof. The operating channel information may include, for example, an operating class and channel number for the beacon. In certain embodiments, the operating channel information may be included with the SMD information, AP information, and nonce/replay counter to avoid a replay attack on a different channel.

The SMD signature generation may further involve generating a hash of the message (e.g., message hash 530) using a hash algorithm 520. The hash algorithm 520 may be any suitable hash algorithm, such as any version of the secure hash algorithm (SHA) (e.g., SHA-256), as an illustrative example. The message hash 530 may be encrypted at an encryption block 540 using a private key 550 to generate the SMD signature 560.

In certain embodiments, the generated SMD signature can be sent in a beacon transmitted by an AP (MLD). In some examples, the SMD Signature (plus nonce/replay counter if used) can be sent as part of the SMD MLD IE in the beacon. In some cases, elliptic-curve cryptography (ECC) can be used to keep the size of the SMD signature smaller. For example, the elliptic curve digital signature algorithm (ECDSA) may result in 64 bytes signature, whereas the Rivest-Shamir-Adleman (RSA) encryption may result in 256 bytes signature. In addition to using ECC, the SMD signature can be hashed to a smaller size, suitable for inclusion in the beacon.

Upon receiving a beacon with the SMD information and the SMD signature, the client may verify the SMD signature using the public key of that SMD over the beacon information used to generate the signature (e.g., SMD information as well as AP MLD information, such as AP MLD MAC address and AP BSSID). If the verification succeeds, then the client has successfully verified that the affiliated AP (and AP MLD) is indeed part of the SMD the AP (MLD) is advertising.

Note, in certain embodiments, the TOFU authentication can also use a self-signed certificate for the root of the chain.

In certain embodiments, the client can employ a public/private key pair (public key infrastructure (PKI)) authentication technique to establish trust for an SMD. In such embodiments, the client(s) get provisioned with a public key of the SMD as part of the client provisioning process. For example, enterprise IT may provision an SMD public key along with SMD Identifier (or MDMI) on the enterprise devices. Such provisioning might include an allow-list for many known-good SMDs. Compared to the TOFU authentication technique, in this case, the public key may not be transmitted to the clients. However, similar to the TOFU authentication technique, an affiliated AP transmitting the MDMI in the beacon frame may include an SMD signature signed over the SMD information+AP MLD information (e.g. AP MLD MAC address+AP BSSID). The SMD signature may be generated by the entity holding the private key for SMD, which may or may not be the AP MLD. In the latter case, the AP MLD may have to communicate with the entity holding the public key to get the SMD signature.

In PKI authentication, a client can verify the received SMD signature based on the SMD public key provisioned for that MDMI on the client. If the signature verification succeeds, then the SMD is considered trusted, and the client has also verified that the affiliated AP (and AP MLD) is indeed part of the SMD that the affiliated AP (MLD) is advertising.

In certain embodiments, the client can employ a certificate authority (CA) signed-certificate based authentication technique to establish trust for a SMD. In such embodiments, the SMD may have a CA signed certificate issued to the SMD by a CA. An entity maintains the private key of the public/private key pair for the SMD. In one embodiment, the SMD certificate may include the SMD Identifier (or MDMI) plus SMD public key plus any additional information about the SMD. The CA issued SMD certificate can be installed on the client devices (e.g. by enterprise IT) as part of the client provisioning out of band.

Similar to the TOFU authentication technique and PKI authentication technique, an affiliated AP transmitting the SMD Identifier (or MDMI) in the beacon frame may get the entity holding the SMD private key to sign the SMD information plus AP MLD information (e.g. AP MLD MAC Address plus AP BSSID) and generate the SMD signature. The AP may include the SMD signature in the beacon frame as well.

In certain embodiments, a client device can verify the received SMD signature based on the SMD public key from the SMD certificate provisioned for that MDMI on the client. If the signature verification succeeds, then the SMD is considered trusted, and the client has also verified that the affiliated AP (and AP MLD) is indeed part of the SMD it is advertising.

In the CA signed-certificate based authentication technique, a second level certificate can be issued for each AP MLD by the SMD, signed by the private key of the SMD. In some examples, the AP MLD certificate includes the AP MLD public key and AP MLD MAC address, among other information. Then both the SMD certificate and AP MLD certificate get installed at the clients, e.g., as part of client provisioning done out of band. Then the AP (MLD) can sign the SMD information plus AP MLD information locally using its own private key (e.g., AP MLD private key) to generate the SMD signature, instead of getting the entity holding the SMD private key to generate the signature. Using the AP (MLD)'s own private key to generate the SMD signature may be a more scalable approach as opposed to using the entity holding the SMD private key to generate the signature. A client device can verify the received SMD signature using the certificate chain provisioned on the device.

In all the three approaches discussed herein (e.g., TOFU authentication, PKI authentication, and CA signed-certificate based authentication), the replay attack for SMD Signature can be avoided by including a nonce or replay Counter in the signature generation. As a result, a new SMD signature may have to be generated for each transmitted beacon.

However, in some architectures, it may not be desired or feasible to generate a new SMD signature every beacon interval. For example, in such architectures, the SMD signature may not include a nonce/replay counter. Additionally, to reduce compute overhead in the network, since generating a PKI signature can be compute intensive, it be desirable to avoid every AP MLD in the SMD having to communicate with the entity holding the SMD private key every beacon interval, e.g. for backhaul scalability reasons (although this is less of a problem with a second level certificate).

Nevertheless, even if the nonce/replay counter plus operating channel information is included in the SMD signature, a MITM could still replay the beacon on the same channel number some amount of time later (e.g., an hour or so later) after radio resource management (RRM) moved the genuine AP to a different channel or genuine AP has been disabled for some reason.

Thus, scenarios that involve avoiding generation of a new SMD signature every beacon interval and scenarios that involve including a nonce/replay counter plus operating channel information in the SMD signature may increase the risk of having a rogue AP (MLD) masquerading as a genuine AP (MLD) part of the SMD and acting as a MITM attacker, by replaying the SMD signature it can retrieve from the beacon frames of a genuine AP. In these deployments, to prevent such MITM attacks, a client can perform additional nonce exchanges with the AP, to verify that the AP (MLD) is indeed part of the SMD by verifying liveness of the SMD signature.

In certain embodiments, for this verification the client-AP exchange flow may involve the following steps:
(a) Client receives the SMD signature and either the public key or MDMI from the beacon. If the MDMI is present in the beacon, then the client uses the MDMI as an identifier for the corresponding public key.
(b) Client generates a CNonce and sends to the AP.
(c) AP generates an ANonce. The AP communicates the CNonce to the SMD key holder (holding the MDM private key) which signs the tuple {CNonce, ANonce, SMD Information (including MDMI), AP MLD Information (AP MLD MAC Address plus AP BSSID), operating class, channel number} and generates a new SMD signature.
(d) The AP sends the generated SMD signature (e.g., live SMD signature) directly to the client. The client verifies the received SMD signature using the SMD public key it knows. If the verification succeeds, the client trusts the SMD and has verified that the AP/AP MLD is indeed part of the SMD advertised.

In certain embodiments, the above protocol can be realized using fast transition (FT) association.

Since the above steps involve additional 1:1 exchanges between the client and the AP, some clients by default may not support this additional verification, and may choose to only verify the received SMD signature from the beacon, without the additional 1:1 exchanges for verifying the SMD signature (e.g., steps (a)-(d)).

In such cases, the clients may use one of the following two approaches, Approach A and Approach B, to verify the received SMD signature from the beacon:

Approach A: If a nonce/replay counter is not used in the SMD signature generation, then the clients could verify the liveness of the SMD signature through additional 1:1 exchange as described in steps (a)-(d) described herein. The client would know if a nonce/replay counter is used since that field is sent in the beacon along with the SMD signature.

Approach B: Using AP-to-AP verification, a genuine AP in the ESS network can perform the steps described in (a)-(d) with other APs it can see over the air, to verify if the AP is indeed part of the advertised SMD. The genuine AP can see other APs that it receives a signal from. If verification does not succeed for one or more APs it is seeing, then the genuine AP can signal presence of such ‘Rogue APs’ to non-AP STAs. However, this measure may not be relied on if a non-AP STA can only see Rogue APs.

In certain embodiments, the SMD signature that is generated using the aforementioned techniques may be sent in a directed probe response to the client, instead of being sent in the beacon. Sending the SMD signature in a directed probe response may provide more efficient resource usage on the AP (e.g., avoiding regeneration of the signature every beacon interval) and can also address replay attack concerns by having the client send a client nonce (CNonce) in the probe request. The SMD signature may include the CNonce and AP nonce (ANonce) and may be sent back in the directed probe response to the client, along with the ANonce. The client (e.g., STA) verifies the SMD signature to pre-authenticate the SMD before associating with the SMD.

In certain embodiments, the SMD signature that is generated using the aforementioned techniques may be sent in an access network query protocol (ANQP) query response message. After discovering an SMD in the beacon, a STA can send an ANQP query request message with a CNonce to the AP. The AP generates an ANonce and includes both CNonce and ANonce in the generation of the SMD signature. The SMD signature is then sent to the STA (along with the ANonce) in the ANQP query response message. The STA verifies the SMD Signature to pre-authenticate the SMD before associating with the SMD.

Advantageously, the aforementioned techniques described herein (e.g., TOFU authentication, PKI authentication, and CA signed-certificate based authentication) enable clients to pre-authenticate a SMD before establishing secure association with the SMD. This ensures that clients do not connect with ‘Rogue APs’ masquerading as APs that are part of a mobility domain. This also avoids MITM attacks by rogue APs in the seamless roaming architecture where clients associate with an MDM (e.g. campus wide ESS network), rather than performing separate association with each AP MLD in the mobility domain.

FIG. 6 depicts an example computing device configured to perform various aspects of the present disclosure, according to one embodiment. Although depicted as a physical device, in embodiments, the computing device 600 may be implemented using virtual device(s), and/or across a number of devices (e.g., in a cloud environment). In one embodiment, the computing device 600 corresponds to a network device (e.g., a computing system), such as the APs 104-1 and 104-2 or the device 106.

As illustrated, the computing device 600 includes a CPU 605, memory 610, storage 615, a network interface 625, and one or more input/output (I/O) interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

The memory 610 can include software programs or applications for generating mobility domain signatures and nonces as discussed above in FIGS. 1-6. Although shown as residing in memory 610, in embodiments, the operation discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
transmitting, from an access point, a signal to a client device indicating the client device should perform an authentication process to authenticate a mobility domain before joining the mobility domain, wherein the access point is part of the mobility domain; and
performing the authentication process with the client device to authenticate the mobility domain.

2. The method of claim 1, wherein the signal transmitted by the access point comprises a Basic Service Set (BSS) membership selector value in a Supported Rates and BSS Membership Selectors element or in an Extended Supported Rates and BSS Membership Selectors element.

3. The method of claim 1, wherein the signal transmitted by the access point comprises an indication in Robust Security Network Element (RSNE) information indicating that the client device should authenticate the mobility domain.

4. The method of claim 1, wherein the signal transmitted by the access point comprises an indication in Robust Security Network Extension Element (RSNXE) information indicating that the client device should authenticate the mobility domain.

5. The method of claim 1, wherein the signal transmitted by the access point is either: a probe response frame, a beacon frame, a reassociation response frame, or another management frame.

6. The method of claim 1, wherein the mobility domain is a seamless mobility domain (SMD).

7. The method of claim 1, wherein the authentication process is started by the client device based on the signal received from the access point.

8. An access point comprising:
one or more memories; and
one or more processors communicatively coupled to the one or more memories, wherein the one or more processors are configured to, individually or collectively, perform operations comprising:
transmitting a signal to a client device indicating the client device should perform an authentication process to authenticate a mobility domain before joining the mobility domain, wherein the access point is part of the mobility domain; and
performing the authentication process with the client device to authenticate the mobility domain.

9. The access point of claim 8, wherein the signal comprises a Basic Service Set (BSS) membership selector value in a Supported Rates and BSS Membership Selectors element or in an Extended Supported Rates and BSS Membership Selectors element.

10. The access point of claim 8, wherein the signal comprises an indication in Robust Security Network Element (RSNE) information indicating that the client device should authenticate the mobility domain.

11. The access point of claim 8, wherein the signal comprises an indication in Robust Security Network Extension Element (RSNXE) information indicating that the client device should authenticate the mobility domain.

12. The access point of claim 8, wherein the signal is either: a probe response frame, a beacon frame, a reassociation response frame, or another management frame.

13. The access point of claim 8, wherein the mobility domain is a seamless mobility domain (SMD).

14. The access point of claim 8, wherein the authentication process is started by the client device based on the signal.

15. A non-transitory computer-readable medium containing computer program code that, when executed by operation of one or more computer processors, performs operations comprising:
transmitting, from an access point, a signal to a client device indicating the client device should perform an authentication process to authenticate a mobility domain before joining the mobility domain, wherein the access point is part of the mobility domain; and
performing the authentication process with the client device to authenticate the mobility domain.

16. The non-transitory computer-readable medium of claim 15, wherein the signal transmitted by the access point comprises a Basic Service Set (BSS) membership selector value in a Supported Rates and BSS Membership Selectors element or in an Extended Supported Rates and BSS Membership Selectors element.

17. The non-transitory computer-readable medium of claim 15, wherein the signal transmitted by the access point comprises an indication in Robust Security Network Element (RSNE) information indicating that the client device should authenticate the mobility domain.

18. The non-transitory computer-readable medium of claim 15, wherein the signal transmitted by the access point comprises an indication in Robust Security Network Extension Element (RSNXE) information indicating that the client device should authenticate the mobility domain.

19. The non-transitory computer-readable medium of claim 15, wherein the signal transmitted by the access point is either: a probe response frame, a beacon frame, a reassociation response frame, or another management frame.

20. The non-transitory computer-readable medium of claim 15, wherein the authentication process is started by the client device based on the signal received from the access point.
